(19) United States
(12) Patent Application Publication
(10) Pub. No.: US 2007/0155621 A1
(43) Pub. Date: Jul. 5, 2007

(54) Ionic liquids as solvents

(76) Inventors: Olivier Lavastre, Gahard (FR); Fabien Bonnette, Bressuire (FR); Abbas Razavi, Mons (BE)

Correspondence Address: FINA TECHNOLOGY INC, PO BOX 674412, HOUSTON, TX, 77267-4412, US

(21) Appl. No.: 10/579,361

(22) PCT Filed: Nov. 5, 2004
(86) PCT No.: PCT/EP04/52820

§ 371 Date: Feb. 23, 2007

(30) Foreign Application Priority Data
Nov. 14, 2003 (FR) 03/13352

(51) Int. Cl. B01J 27/24; C08F 4/44

(52) U.S. Cl. 502/200; 526/161; 526/351; 526/352

(57) ABSTRACT

The present invention discloses a method for preparing a dissolved catalyst component comprising the steps of: a) providing a halogenated precursor component of formula (I) X—[CH2—]— b) reacting the halogenated bisimine precursor with an ionic liquid precursor in a solvent to prepare an ionic liquid; c) mixing in a solvent one equivalent of the ionic liquid prepared in step b) with a metallic complex of formula (II) L₂MY₂ wherein L is a coordinating ligand for the metallic site, said coordination being achieved by phosphorus, nitrogen or oxygen; d) evaporating the solvent; and e) retrieving a hybrid single site catalyst component/ionic liquid system. It also discloses an active catalyst system heterogenised by an ionic liquid and its use in the polymerisation of olefins.

The present invention relates to the use of ionic liquids to heterogenise catalyst components and to the use of these solid insoluble systems for the polymerisation of olefins.

Ionic liquids have been described in literature such as for example in U.S. Pat. No. 5,994,602, or in WO096/18459 or in WO001/81353. They disclose various methods for preparing ionic liquids and various applications.

These applications comprise oligomarisation of eth ene, propene or butene with various nickel-based precursors dissolved in ionic liquids as disclosed for example in Dupont et al. (Dupont, J., de Souza R. F., Suarez P. A. Z., in Chem. Rev., 102, 3667, 2002.). The same document also discloses that Ziegler -Natta type polymerisation can be carried out in dialkylimidazolium halides/ammonium halide ionic liquids using AICI₃₋ₓRₓas cocatalysts.

Other applications include the use of ionic liquids that are liquid at or below room temperature as solvents for transiti on-metal-mediated catalysis, such as described for example in Welton (Welton T., in Chem. Rev., 99, 2071, 1999.). Most attempts have proven successful in dimerisation or oligomerisation, but polymerisation remains problematic, especially with single site catalyst components.

In many polymerisation methods such as for example in slurry processes, it is important to support the catalyst component.

There is thus a need to develop new supports for single site catalyst systems that are active in the polymerisation of alpha-olefins, and new methods for preparing these new supported catalyst systems.

It is an aim of the present invention to provide a method for preparing a single site catalyst component heterogenised by ionic liquids.

It is another aim of the p resent invention to provide an heterogenised single site catalyst component.

It is a further aim of the present invention to provide a process for polymerising alpha-olefins using such heterogenised single site catalyst component.

It is also an aim of the present invention to prepare new polymers with said new catalyst system.

Accordingly, the present invention discloses a method for preparing an heterogenised single site catalyst component for the polymerisation of alpha-olefins that comprises the steps of:
a) providing a halogenated precursor component of formula (I)
   X—[—CH₂—]ₙ—CH₃ (I)
b) reacting the halogenated precursor with an ionic liquid precursor in a solvent or without solvent to prepare an ionic liquid;
c) mixing in a solvent one equivalent of the ionic liquid obtained in step b) with a metallic complex of formula (II)
   L₂MY₂ (II)
   wherein L is a coordinating ligand for the metallic site, said coordination being achieved by phosphorus, nitrogen or oxygen atoms. L is preferably phophine, imine, aryloxy, alkyloxy or a mixture thereof. M is a metal selected from Ni or Pd or Fe and Y is a halogen or an alkyl having from 1 to 12 carbon atoms;
d) evaporating the solvent;
e) retrieving an hybrid catalyst component/ionic liquid system.

All reactions are carried under argon at atmospheric pressure, using the standard Schlenk or glovebox techniques.

The halogenated precursor of formula (I) reacts with an ionic liquid precursor, preferably with N-alkylimidazole or pyridine, in or without a solvent, said solvent if present being for example tetrahydrofuran (THF), CH₂Cl₂ or CH₃CN.

In the ionic liquid, the anion X⁻ can be selected from Cl⁻, Br⁻, I⁻, BF₄⁻, PF₆⁻, AsF₆⁻, SbF₆⁻, NO₂⁻ and NO₃⁻. It can also be selected from compounds of formula AIR_{4-z}A″_{z} wherein R can be selected from an alkyl having from 1 to 12 carbon atoms, substituted or unsubstituted, or from a cycloalkyl having 5 or 6 carbon atoms, substituted or unsubstituted, or from an heteroalkyl, substituted or unsubstituted, or from an heterocycloalkyl, substituted or unsubstituted, or from an aryl having 5 or 6 carbon atoms, substituted or unsubstituted, or from an heteroaryl, substituted or unsubstituted, or from an alkoxy, an aryloxy, an acyl, a silyl, a boryl, a phosphino, an amino, a thio or a seleno, wherein A″ is a halogen and wherein z is an integer from 0 to 4. The cationic part of the ionic liquid may be prepared by protonation or alkylation of a compound selected from imidazolium, pyrazoline, thiazole, triazole, pyrrole, indone, tetrazole, pyridine, pyrimidine, pyrazine, pyridazine, piperazine or piperidine.

Preferably, the anion X⁻ is Br⁻ or BF₄⁻, and preferably the cationic is derived from imidazolium or pyridinium. The preferred ionic liquid precursors are thus N-alkyl imidazole or pyridine.

If the ionic liquid precursor is N-alkyl-imidazolium, the reaction is carried out at a temperature of from 50 to 150° C., preferably of from 80 to 120° C. and for a period of time of from 1 to 24 hours, preferably of from 2 to 6 hours. The resulting intermediate product is an ion pair of formula III

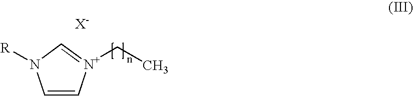

If the ionic liquid precursor is pyridinium, the reaction is carried out at a temperature of from 50 to 120° C., preferably of from 90 to 110° C. and for a period of time of from 1 to 24 hours, preferably of about 3 hours. The resulting product is an ion pair of formula IV

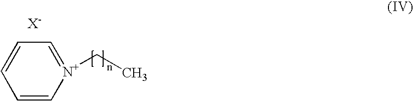

The intermediate product III or IV are mixed in stoechiometric proportions with the metallic complex of formula L₂MY₂ in a solvent selected typically from CH₂Cl₂, THF, or CH₃CN, at room temperature (about 25° C.), for a period of time of from 1 to 24 hours, preferably of from 1 to 2 hours. The resulting product is a component of formula V if the ionic liquid precursor is a N-alkyl-imidazolium 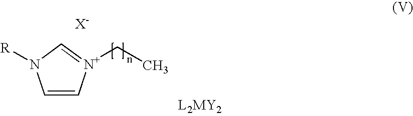
or of formula VI if the ionic liquid is pyridinium 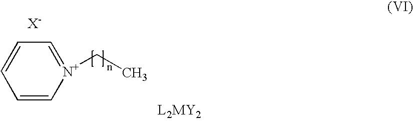
wherein M, Ar and Y are as defined here-above.

Optionally, before the dissolution of the complex is carried out, the intermediate product (III) or (IV) can be reacted with a salt C⁺A⁻, wherein C⁺ is a cation that can be selected from K⁺, Na⁺, NH₄⁺, and A⁻ is an anion that can be selected from PF₆⁻, SbF₆⁻, BF₄⁻, (CF₃—SO₂)₂N⁻, ClO₄⁻, CF₃SO₃⁻, NO₃⁻ or CF₃CO₂⁻. The reaction is carried out in a solvent selected typically from CH₂Cl₂, THF or CH₃CN at a temperature of from 50 to 80° C., preferably of about 60° C. and for a period of time of from 6 to 48 hours, preferably of from 16 to 24 hours.

The mixing with the ligand is then carried out as previously leading to an ion pair representing a supported catalytic component of formula VII if the ionic liquid is N-alkyl-imidazolium 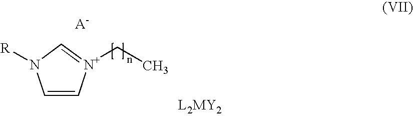
or of formula VIII if the ionic liquid is pyridinium

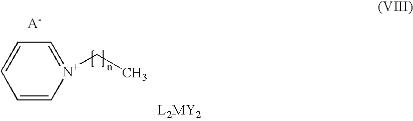

The present invention also discloses an hybrid organometallic complex/ionic liquid catalyst system, obtainable by the method described here-above.

An active catalyst system is then obtained by addition of an activating agent.

The activating agent can be selected from alumoxanes or aluminium alkyls or boron-based activating agents depending upon the nature of Y.

The aluminium alkyls are of the formula AlRₓ and can be used wherein each R is the same or different and is selected from halides or from alkoxy or alkyl groups having from 1 to 12 carbon atoms and x is from 1 to 3. Especially suitable aluminiumalkyl are dialkylaluminum chloride, the most preferred being diethylaluminum chloride (Et₂AlCl).

The preferred alumoxanes comprise oligomeric linear and/or cyclic alkyl alumoxanes represented by the formula: 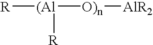
for oligomeric, linear alumoxanes
and 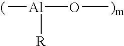
for oligomeric, cyclic alumoxanes,
wherein n is 1-40 , preferably 10-20, m is 3-40, preferably 3-20 and R is a C₁-C₈ alkyl group and preferably methyl.

Methylalumoxane (MAO) is preferably used.

Suitable boron-based activating agents may comprise triphenylcarbenium boronate such as tetrakis-pentafluorophenyl-borato-triphenylcarbenium [C(Ph)₃⁺B(C₆F₅)₄⁻] as described in EP-A-0,427,696

Other suitable boron-containing activating agents are described in EP-A-0,277,004.

The amount of activating agent is such that the Al/M ratio is of from 100 to 1000.

After activation and elimination of the solvent, an apolar solvent is added to the hybrid system resulting in quantitative precipitation in powder form. The solvent phase is colourless and no longer contains any soluble catalyst. The solvent is selected to generate a powder that disperses easily therein. The powder is then injected into the reactor as dispersion.

The present invention further provides a method for homopolymerising or for copolymerising alpha-olefins that comprises the steps of:
a) injecting into the reactor an apolar solvent, then the heterogenised catalytic component and an activating agent;
b) injecting the monomer and optional comonomer into the reactor,
c) maintaining under polymerisation conditions;
d) retrieving the polymer under the form of chips or blocks.

The conditions of temperature and pressure for the polymerisation process are not particularly limited.

The pressure in the reactor can vary from 0.5 to 50 bars, preferably from 1 to 20 bars and most preferably from 4 to 10 bars.

The polymerisation temperature can range from 10 to 100° C., preferably from 20 to 50° C. and most preferably at room temperature (about 25° C.).

The solvent is apolar and is typically selected from an alkane, preferably n-heptane.

The reaction is carried out for a period of time of from 30 minutes to 24 hours.

The monomer that can be used in the present invention are alpha-olefins having from 3 to 8 carbon atoms and ethylene, preferably it is ethylene and propylene.

### EXAMPLES

All reactions were carried out on a vacuum line under argon using standard glovebox and Schlenk techniques.

During activation, the use of ionic liquids results in the formation of a precipitate that can be easily injected into the reactor.

The polymerisation, in the presence of ionic liquids produces polyethylene with unmodified structure (same fusion temperature, same molecular weight, same polydispersity index) but with a different macroscopic aspect. The polymer particles have a larger size than that of particles obtained with nickel based catalyst system used without ionic liquids (see Table 1).

The polymer particles have a diameter of at least 0.5 mm. They are thus less dangerous and easier to handle than powders (see Table II).

It is also observed that the fusion temperature of the polyethylene is comparable to that of polyethylene prepared with conventional catalyst systems.

The nature of the ionic liquid plays a significant role in the morphology of the resulting polymer as can be seen in Table II showing that the particle sizes of polymers prepared with ionic liquid based respectively on imidazolium or pyridinium are very different. The catalytic systems based on ionic liquids of pyridinium type produce polymers having particle sizes of at least 2 mm whereas catalytic systems based on ionic liquid of imidazolium type produce polymers having particle sizes of about 0.5 mm.

Synthesis of Catalyst Components Heterogenised by Different Ionic Liquids.

Synthesis of 1-methyl-3-pentylimdazolium bromide (III).

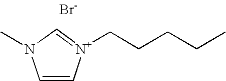

9.96 mL of N-methylimidazole (125 mmole) were introduced in a Schlenk followed by 22.16 mL of bromopentane (187.5 mmoles). The reaction medium was stirred during 2 hours at a temperature of 90° C. After cooling down to room temperature, 40 mL of diethylic ether were added, to form a white precipitate. After filtration, the precipitate was washed 4 times with 40 mL of diethylic ether. After filtration, 24.7 g of a white solid were obtained with a yield of 85%.

The NMR spectra were as follows:

¹H NMR (300 MHz, CDCl₃) δ: 10.23 (s, 1), 7.63 (tr, 1), 7.47 (tr, 1), 4.27 (tr, 2), 1.86(q, 2), 1.29(m,4), 0.82(tr, 3).

¹³C NMR (75 MHz, CDCl₃) δ: 137.17, 123.77, 122.09, 50.01, 36.67, 29.92, 28.17, 21.98, 13.76.
Synthesis of N-pentyl pyridinium bromide (IV):

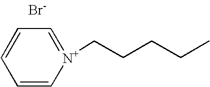

0.4 mL of pyridine (5 mmoles) were introduced in a Schlenk followed by 0.8 mL of bromopentane (7.5 mmoles). The reaction medium was stirred during 2 hours at a temperature of 100° C. until formation of a precipitate. After cooling down to room temperature, the precipitate was washed 3 times with 5 mL of diethylic ether. After filtration and drying under reduced pressure, 1.09 g of a cream-coloured solid were obtained with a yield of 95%.

The NMR spectra were as follows:

¹H NMR (300 MHz, CDCl₃) δ: 9.58 (d, 2), 8.52 (tr, 1), 8.11 (tr, 2), 4.93 (tr, 2), 1.98 (q, 2), 1.28 (m, 4), 0.77 (tr, 3).

¹³C NMR (75 MHz, CDCl₃) δ: 145.18, 128.47, 61.80, 31.66, 27.92, 22.02, 13.75.
Synthesis of the Nickel-Based Catalyst Component.

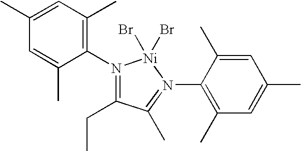

9.96 mg (0.028 mmoles) of bisimine were introduced in a Schlenk under inert atmosphere, followed by 5 mL of dichloromethane. 6.78 mg (0.02 mmoles) of (DME)NiBr₂ were then added and the system was stirred during 16 hours at room temperature (about 25° C.). The solvent was evaporated and the residue was washed twice with 3 mL of diethylic ether. After filtration and drying, 7 mg of brown powder were obtained with a yield of 63%.
Synthesis of Fe-Based Catalyst Component.

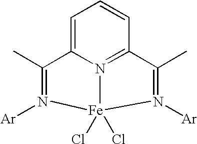

45.77 mg (0.23 mmoles) of tetrahydrated Fe(II) chloride were dried under reduced pressure at a temperature of 120° C. during 5 hours. The Fe(II) chloride was added to bisimine in THF. The reaction medium remained under agitation at reflux during 30 minutes, it was then cooled down to room temperature. The iron complex appeared as a precipitate. The mixture was filtered, dried under reduced pressure to produce 0.104 g of a blue complex with a yield of 87%.

Synthesis of Compounds V and VI.

The catalyst component was dissolved in CH₂Cl₂ and the ionic liquid dissolved in the same solvent was then added. The reaction medium was stirred during one hour at room temperature and the solvent was then evaporated under reduced pressure. The quantities were respectively as follows:
compound V_{Ni}: 5 micromoles (2.7 mg) of Ni-based catalyst, 5 micromoles (1.17 mg) of 1-methyl-3-pentylimidazolium in 4 mL of CH₂Cl₂.
compound V_{Fe}: 1.2 micromoles (0.73 mg) of Fe-based catalyst, 1.2 micromoles (0.28 mg) of 1-methyl-3-pentylimidazolium in 1 mL of CH₂Cl₂.
compound VI_{Fe}: 1.2 micromoles (0.73 mg) of Fe-based catalyst, 1.2 micromoles (0.276 mg) of N-pentylpyridinium in 1 mL of CH₂Cl₂.
   Polymerisation of Ethylene.
   Polymerisation of Ethylene in the Ni-Based catalyst system.

The polymerisation conditions were as follows:
5 micromoles of catalyst component, 5 micromoles of ionic liquid and 60 mL of n-heptane;
addition of 300 mole-equivalents of MAO with respect to the catalyst component;
T=25° C.;
P=4 bars;
t=2hours;

the polymer was treated with acid methanol (10vol % of HCl)

TABLE I

| | | mass | | | |
|---|---|---|---|---|---|
| | | PE | kg PE/mol | | Tf |
| catalyst IIa | solvent | (mg) | cata/hr^{a} | structure PE | ° C. |
| alone | n- | 5214 | 680 | part./powder | 130 |
| | heptane | | | | |
| heterogenised^{b} | n- | 2338 | 371 | particles | 130.5 |
| | heptane | | | | |

^{a}measured after one hour
^{b}ionic liquid was 1-methyl-3-pentylimidazolium bromide.

Polymerisation of Ethylene with Fe-Based Catalyst System.

The polymerisation with the Fe-based catalyst system were as follows:
1.2 micromoles of catalyst component, 1.2 micromoles of ionic liquid and 60 mL of n-heptane;
addition of 1000 mole-equivalents of MAO with respect to the catalyst component;
T=25° C.;
P=4 bars;
t=1 hour;

the polymer was treated with acid methanol (10vol % of HCl).

TABLE II

| | | | mass | | | |
|---|---|---|---|---|---|---|
| Exam- | catalyst | | PE | Tm | kgPE/mol | |
| ple | IIb | solvent | (g) | (° C.) | cata/hr^{a} | Structure |
| 1 | alone | n- | 9.4 | 134.7 | 8103 | fine |
| | | heptane | | | | powder |
| 2 | +1equ.ionic | n- | 7.9 | 132.5 | 7150 | micro- |
| | liquid^{b} | heptane | | | | particles |
| 3 | +1equ.ionic | n- | 7.0 | 136.3 | 5579 | particles |
| | liquid^{c} | heptane | | | | |

^{a}measured after one hour
^{b}ionic liquid was 1-methyl-3-pentylimidazilium bromide
^{c}ionic liquid was N-pentylpyridinium bromide.

1. A method for preparing a dissolved catalyst component comprising the steps of:
a) providing a halogenated precursor component of formula (I)
—X—[—CH₂—]— (I)
b) reacting the halogenated precursor with an ionic liquid precursor in a solvent to prepare an ionic liquid;
c) mixing in a solvent one equivalent of the ionic liquid prepared in step b) with a metallic complex of formula (II)
L₂MY₂ (II)
wherein L is a coordinating ligand for the metallic site, said coordination being achieved by phosphorus, nitrogen or oxygen;
d) evaporating the solvent; and
e) retrieving a hybrid single site catalyst component/ionic liquid system.

2. The method of claim 1 wherein the Ionic liquid precursor is N-alkyl-imidazolium or pyridinium.

3. The method of claim 1 or claim 2 wherein between step b) and step c), the reaction product of step b) is reacted with an Ionic compound C⁺A⁻, wherein C⁺ is a cation selected from K⁺, Na⁺, NH₄⁺, and A⁻ is an anion selected from PF₆⁻, SbF₆⁻, BF₄⁻, (CF₃—SO₂)₂N⁻, ClO4⁻; CF₃SO₃⁻, NO₃⁻ or CF₃CO₂⁻.

4. The method of any one of the preceding claims wherein the solvent used in steps b) and step c) is selected from THF, CH₂Cl₂ or CH₃CN.

5. A hybrid organometallic complex/ionic liquid system obtainable by the method of any one of claims 1 to 4.

6. A hybrid catalyst system comprising the hybrid organomet allic complex/ionic liquid system of claim 5 and an activating agent.

7. The hybrid catalyst system of claim 6 wherein the activating agent is methylaluminoxane and wherein Y is a halogen.

8. The hybrid catalyst system of claim 7 wherein the amount of methylaluminoxane is such that the Al/M ratio Is of from 100 to 1000.

9. A method for homopolymerising or copolymerising alpha-olefins that comprises the steps of:
a) heterogenising the hybrid catalyst system of any one of claims 6 to 8 by addition of an apolar solvent;
b) injecting into the reactor an apolar solvent and the heterogenised catalyst system of step a)
c) injecting the monomer and optional comonomer into the reactor;
d) maintaining under polymerisation conditions;
e) retrieving the polymer under the form of chips or blocks.

10. The method of claim 9 wherein the apolar solvent is n-heptane.

11. The method of claim 9 or claim 10 wherein the monomer is ethylene or propylene.

12. A polymer having particle sizes of at least 0.5 mm obtainable by the process of any one of claims 9 to 11.

13. A method for the preparation of dissolved catalyst component comprising:
a) providing a halogenated precursor component characterized by the formula:
X [CH₂]ₙ CH₃ (I)
wherein X is an halogen and ₙ is an interger within the range of 1-12;
b) reacting the halogenated precursor with an ionic liquid precursor to prepare an ionic liquid;
c) mixing in a solvent one equivalent of the ionic liquid prepared in paragraph b) with a metallic complex of the formula:
L₂MY₂ (II)
wherein L is a coordinating ligand for the metallic site providing coordination achieved by phosphorus, nitrogen or oxygen, M is nickel palladium or iron, and Y is a halogen or a C₁-C₁₂ alkyl group;
d) evaporating the solvent; and
e) recovering a hybrid single site catalyst component/ionic liquid system.

14. The method of claim 13 wherein the ionic liquid precursor is an N-hydrocarbyl imidazole or pyridine.

15. The method of claim 14 wherein said ionic liquid precursor is an N—R imidazole in which R is an aryl group or an alkyl group having from 1-12 carbon atoms.

16. The method of claim 14 wherein the ionic liquid is 1-methy-3-pentylimidazolium bromide or N-pentyl pyridinium bromide.

17. The method of claim 13 further comprising prior to subparagraph c) reacting said ionic liquid with an ionic compound characterized by the formula C⁺A⁻ wherein C⁺ is a cation selected from the group consisting of K⁺, Na⁺, NH₄⁺, and A⁻ is an anion selected from the group consisting of PF₆^{′}, SbF₆⁻, BF₄⁻, (CF₃—SO₂)N⁻, ClO₄⁻, CF₃—SO₃)₂N⁻, ClO₄⁻, CF₃ SO₃⁻, NO₃⁻ and CF₃CO₂⁻.

18. The method of claim 13 wherein said solvent is selected from a group consisting of tetrahydrofuron, methylene dichloride, and acetonnitrile.

19. A hybrid organometallic complex/ionic liquid system produced by the method of claim 13.

20. A hybrid catalyst system comprising the hybrid organometallic complex/ionic liquid system of claim 19 and an activating agent.

21. The hybrid catalyst system of claim 20 wherein the activating agent is methylaluminoxane and Y is halogen.

22. The hybrid catalyst system of claim 21 wherein the methylaluminoxane is present in an amount to provide an Al/M ratio within the range of 100 to 1,000.

23. A method for the preparation of an alpha olefin polymer comprising:
a) providing a catalyst system comprising a single site catalyst component produced by the process of claim 13 and an activating agent for said catalyst component;
b) adding an apolar solvent to said catalyst system to heterogenise said catalyst system;
c) introducing said heterogenised catalyst system in an apolar solvent and an alpha olefin monomer into a polymerization reactor;
d) operating said reactor under polymerization conditions; and
e) recovering an alpha olefin polymer product from said reactor.

24. The method of claim 23 wherein said alpha olefin monomer comprises ethylene or propylene.

25. The method of claim 24 wherein said apolar solvent is n-heptane.

26. The method of claim 25 wherein said activating agent is methylalumoxane and wherein said polymer product recovered from said polymerization reactor is in the form of chips or blocks.

27. The process of claim 24 wherein said polymer product recovered from said reactor contains polymer particles having a diameter of at least 0.5 mm.

28. The method of claim 24 wherein said methyalumoxane is employed in an amount to provide a ratio of aluminum to the metal M within the range of 100-1,000.

29. The method of claim 24 wherein the ionic liquid is an puridenum compound and the polymer product recovered from said polymerization reactor comprises polymer particles having a diameter of at least 2 mm.

30. The method of claim 24 wherein the ionic liquid is an imidazolium compound and the polymer product recovered from said polymerization reactor comprises polymer particles having a diameter of about 0.5 mm.
